(19) United States
(12) Patent Application Publication
(10) Pub. No.: US 2009/0024632 A1
(43) Pub. Date: Jan. 22, 2009

(54) Method of and System for Controlling Private Data in Web-Based Applications

(76) Inventors: Vijay Dheap, Durham, NC (US); Joel Alan Farrell, Ashland, MA (US); David Preston Sink, Raleigh, NC (US)

Correspondence Address: DILLON & YUDELL LLP, 8911 N. CAPITAL OF TEXAS HWY., SUITE 2110, AUSTIN, TX, 78759, US

(21) Appl. No.: 11/779,929

(22) Filed: Jul. 19, 2007

(51) Int. Cl. G06F 17/30

(52) U.S. Cl. 707/10; 707/E17.01

(57) ABSTRACT

A method of and system for providing content and services includes web-based application that is hosted on a server. The application includes web-provided services and private data. The private data is contained in a data source. The application includes a place holder for the private data. The place holder is tagged with the data type, format, and data elements required for the application. A personal syndication manager that is associated with an application user. The personal syndication manager is communication with the server. The personal syndication manager is also in communication with registered data sources. The personal subscription manager is configured to convert the private data to a content syndication format required by the application. The personal subscription manager is also configured to terminate a subscription upon the occurrence of an event, such as the expiration a subscription period.

### BACKGROUND OF THE INVENTION

1. Technical Field

The present invention relates generally to the field of Web-based applications, and more particularly to a method of and system for controlling access to private data used in web-based applications, such as mashups and software-as-a-service (SaaS) applications.

2. Description of the Related Art

A mashup is typically a web-based application that combines two or more sources of content and services into a single application. A mashup can be composed of public data, private data, and logic capabilities that either operate on the data or provide a specialized view into the data. The various components of the mashup are then wired together based on the needs of the mashup creator. Examples of mashups include those that combine one or more databases with mapping services to provide a geographical view of the location of items in the database. However, the types of applications that can be formed using mashups are limited only by the imagination of mashup creators.

With the growing popularity of mashups and other situational applications that combine Web services and/or content with private data, the issue of control over data used in the mashups needs to be addressed. As more and more data sources are made accessible, mashups will become more useful and more personal. The reason mashups will become more personal is that more personal, proprietary, and potentially confidential data sources can be leveraged to construct interesting and relevant situational applications.

Most mashups are web-based in that they use a browser as a universal client. Accordingly, mashups are hosted outside the user's personal domain. This architecture simplifies the process of sharing mashups and allows access to the mashups from any browser equipped device. Currently, this architecture requires the mashup creator to upload and store private data on the mashup server. However, relinquishing control over a copy of private data may cause several problems. For example, if data is changed in the mashup, then that data will need to be synchronized with the original source of the data. Additionally, moving data outside the user's direct control and having multiple copies of the data increases the possibility of exposure and loss of private or sensitive data.

### SUMMARY OF THE INVENTION

The present invention provides a method of and system for providing content and services with a web-based application, such as a mashup hosted on a mashup server. The application according to the present invention includes Web-provided services and private data. The private data is contained in a data source. The application includes a place holder for the private data rather than a copy of the data itself. The place holder is tagged with the data type, format, and data elements required for the application.

The system of the present invention includes a personal syndication manager that is associated with an application user. The personal syndication manager is in communication with the server. The personal syndication manager is also in communication with data sources registered with the personal syndication manager by the user. The personal subscription manager is configured to convert the private data to a content syndication format required by the application. The personal subscription manager is also configured to terminate a subscription upon the occurrence of an event, such as the expiration a subscription period.

When a user wants to use an application hosted on the server, the user requests the application from the server. The server determines if the requested application requires private data. If not, the server provides the mashup to the requesting user. If the application does require private data, the server determines if the requesting user is associated with a personal syndication manager and the data source of the private data is registered with the personal syndication manager. If not, the server prompts the requesting to install a personal syndication manager and/or register the data source with the personal syndication manager. If the data source is registered with a personal syndication manager associated with the requesting user, the server subscribes to the data source, through the personal syndication manager, and provides the application to the requesting user. Upon the occurrence of an event, such as the expiration a subscription period, the personal subscription manager terminates the server's subscription to the data source.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a system according to the present invention;

FIG. 2 is a block diagram of a typical mashup;

FIG. 3 is a flow chart of mashup creation according to an embodiment of the present invention;

FIG. 4 is a flow chart of an embodiment of mashup server processing according to the present invention;

FIG. 5 is a flow chart of an embodiment of personal data manager processing according to the present invention; and,

FIG. 6 is a block diagram of an information handling system adapted to embody systems and methods according to the present invention.

### DETAILED DESCRIPTION OF THE PREFERRED EMBODIMENT

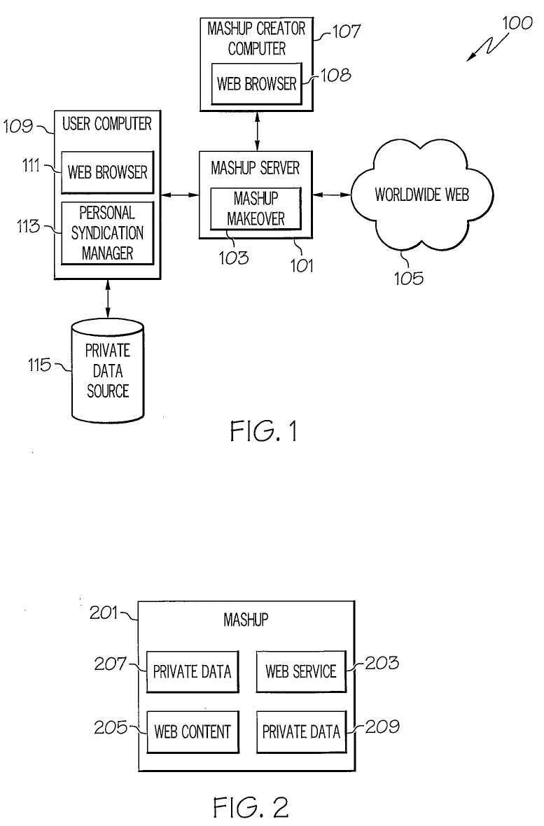

Referring now to the drawings, and first FIG. 1, a system according to the present invention is designated generally by the numeral 100. System 100 includes a mashup server 101. Mashup server 101 is adapted to store, and serve to users, mashups. As is known to those skilled in the art, a mashup is a web-based application that combines content and services from more than one source into an integrated experience. Other examples of web-based applications that combine content and services from more than one source include software-as-a-service applications, and the like. Mashup server 101 may include a mashup maker 103. Examples of mashup makers include Microsoft® PopFly™ and IBM QEDWiki™. Mashup maker 103 provides an environment in which to create mashups. Mashup server 101 is coupled to the World Wide Web 105 from which it may access Web content and Web services. Mashup server 101 is also coupled to one or more mashup creator computers, including mashup creator computer 107, and one or more user computers, including a user computer 109.

Mashup creator computer 107 and user computer 109 may be personal computers, notebook computers, personal digital assistants, or any other computing devices. Mashup creator computer includes a Web browser 108 that enables a mashup creator to access mashup maker 103. User computer 109 includes a web browser 111 that allows it to access mashups from mashup server 101 as well as other Web content. User computer 109 also includes a personal syndication manager 113. The operation of personal syndication manager (PSM) 113 will be discussed in detail hereinafter. Generally, PSM 113 provides data from a private data source 115 to mashup server 101.

FIG. 2 illustrates a block diagram of a typical mashup 201. The mashup 201 includes web services 203. Mashup 201 may also include Web content 205. According to embodiments of the present invention, mashup 201 also includes one or more sources of private data 207 and 209.

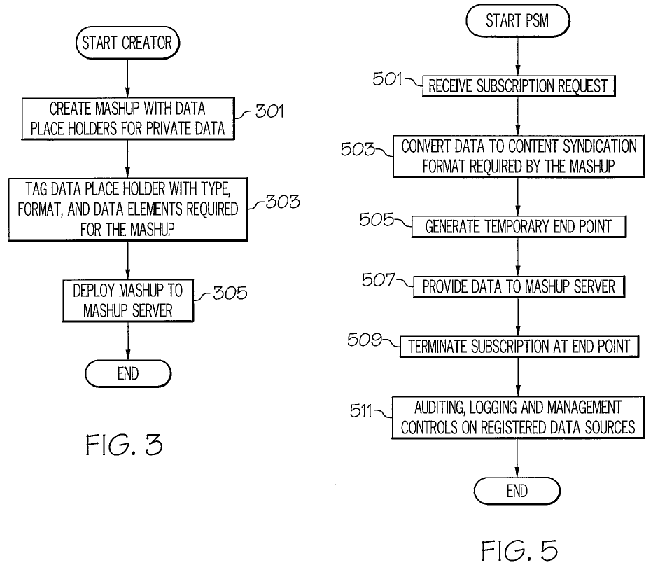

FIG. 3 illustrates the steps performed by a mashup creator according to embodiments of the present invention. The steps of FIG. 3 are performed by a human mashup creator with the aid of a computer and a mashup maker. First, the mashup creator creates a mashup, preferably using a mashup maker, including both Web services and private data, as indicated at block 301. Rather than uploading to the mashup maker the private data itself, the mashup creator leaves a place holder for the private data. As will be explained in detail hereinafter, according to the present invention the mashup subscribes to the private data as if it were public Web content. The mashup may include Web content as well as private data. Then, the mashup creator tags the placeholder or holders with the data type, format, and data elements of the private data required for the mashup, as indicated at block 303. Then, the mashup creator deploys the mashup to the mashup server, as indicated at block 305.

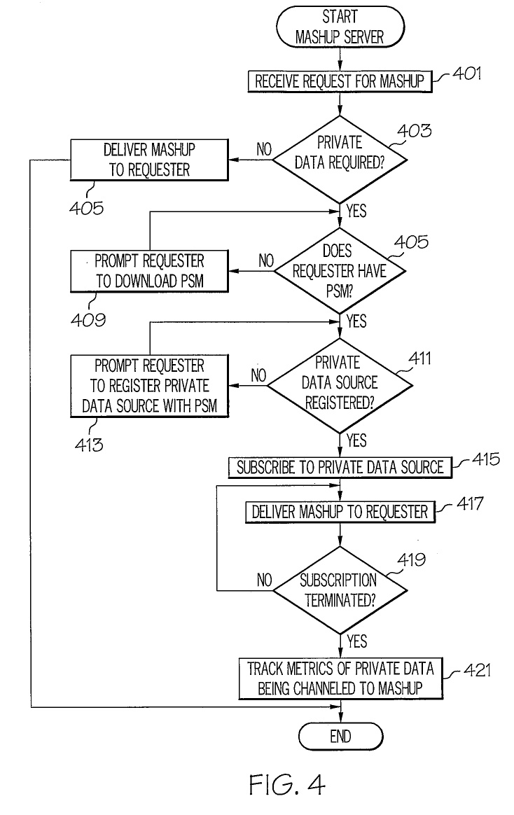

FIG. 4 is a flow chart of mashup server processing according to an embodiment of the present invention. The mashup server receives a request for a mashup, as indicated at block 401. The mashup server determines, at decision block 403, if private data is required for the requested mashup. If not, the mashup server delivers the requested mashup to the requester, at block 405, and processing ends. If, as determined at decision block 403, private data is required, the mashup server determines, at decision block 407, if the requester has a PSM. If not, the mashup server prompts the requester to download a PSM, as indicated at block 409. If, as determined at decision block 407, the requester does have a PSM, the mashup server determines, at decision block 411, if the private data source is registered with the PSM. If not, the mashup server prompts the requester to register the private data source with the PSM, as indicated at block 413. If, as determined at decision block 411, the private data source is registered with the PSM, the mashup server subscribes to the private data source, as indicated at block 415, and delivers the mashup to the requester, as indicated at block 417. The delivery of the mashup to the requester continues until the PSM terminates the subscription, as indicated at decision block 419. As indicated at block 421, the mashup server may track metrics of private data being delivered or channeled to the mashup. Examples of metrics include time duration, size of data, and the like.

FIG. 5 is a flow chart of PSM processing according to an embodiment of the present invention. The PSM receives a subscription request, as indicated at block 501. The PSM converts data to the content syndication format required by the mashup, as indicated at block 503. The native format of the data may be Microsoft® Excel®, Microsoft® Access®, DB2®, Oracle® DB, PeopleSoft®, etc. The PSM converts the data to a syndication formats such as RSS, Atom, JSON, etc., as required by the mashup. The conversion may be done in real time as the data is requested. Alternatively, the data may be batch formatted and cached for future use.

After converting the data to the content syndication format required by the mashup, at block 503, the PSM generates a temporary end point for the subscription, as indicated at block 505, according to a predetermined policy. The temporary end point may be a time at which the subscription will expire. The temporary end point may also be based on geography or some other criteria. After generating the temporary end point, at block 505, the PSM provides the data to the mashup server, as indicated at block 507. When the temporary end point generated at block 505 is reached, the PSM terminates the subscription, as indicated at block 509. The PSM may perform auditing, logging, and management controls on registered data sources, as indicated at block 511.

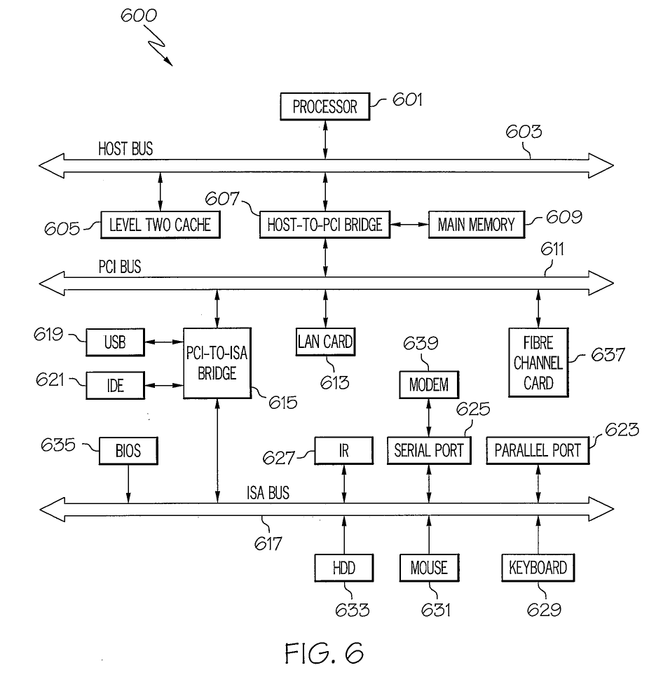

Referring now to FIG. 6, there is illustrated a block diagram of a generic information handling system 600 capable of performing the server and client operations described herein. Computer system 600 includes processor 601 which is coupled to host bus 603. Processor 601 preferably includes an onboard cache memory. A level two (L2) cache memory 605 is also coupled to host bus 603. A Host-to-PCI bridge 607 is coupled to host bus 603. Host-to-PCI bridge 607, which is coupled to main memory 609, includes its own cache memory and main memory control functions. Host-to-PCI bridge 607 provides bus control to handle transfers among a PCI bus 611, processor 601, L2 cache 605, main memory 609, and host bus 603. PCI bus 611 provides an interface for a variety of devices including, for example, a local area network (LAN) card 613, a PCI-to-ISA bridge 615, which provides bus control to handle transfers between PCI bus 611 and an ISA bus 617, a universal serial bus (USB) 619, and an IDE device 621. PCI-to-ISA bridge 615 also includes onboard power management functionality. PCI-to-ISA bridge 615 can include other functional elements not shown, such as a real-time clock (RTC), DMA control, interrupt support, and system management bus support.

Peripheral devices and input/output (I/O) devices can be attached to various interfaces or ports coupled to ISA bus 617. Such interfaces or ports may include a parallel port 623, a serial port 625, an infrared (IR) interface 627, a keyboard interface 629, a mouse interface 631, and a hard disk drive (HDD) 633.

A BIOS 635 is coupled to ISA bus 617. BIOS 635 incorporates the necessary processor executable code for a variety of low-level system functions and system boot functions. BIOS 635 can be stored in any computer readable medium, including magnetic storage media, optical storage media, flash memory, random access memory, read only memory, and communications media conveying signals encoding the instructions (e.g., signals from a network). In order to couple computer system 600 to another computer system to copy files or send and receive messages over a network, LAN card 613 may be coupled to PCI bus 611. Similarly, a Fibre Channel card may be coupled to PCI bus 613. Additionally, a modem 639 may be coupled to ISA bus 617 through serial port 625 to support dial-up connections.

While the computer system described in FIG. 6 is capable of executing the invention described herein, the illustrated system is simply one example of a computer system. Those skilled in the art will appreciate that many other computer system designs are capable of performing the invention described herein.

One of the preferred implementations of the invention is an application, namely, a set of instructions (program code) in a code module that may, for example, be in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Although invention has been illustrated and described in detail with respect to mashups, those skilled in the art will appreciate that embodiments of the present invention are applicable to other web-based applications. Accordingly, the foregoing description is intended for purposes of illustration and not of limitation.

What is claimed is:

1. A method of providing content and services, which comprises:
making a web-based application comprising web-provided services and private data, said private data being contained in a data source;
leaving a place holder in said application for said private data; and,
deploying said application to an application server.

2. The method as claimed in claim 1, further comprising:
tagging said place holder with type, format and data elements required for said application.

3. The method as claimed in claim 1, further comprising:
registering said data source with a personal syndication manager.

4. The method as claimed in claim 1, further comprising:
converting said private data to a content syndication format required by said application.

5. The method as claimed in claim 1, further comprising:
receiving a request for said application from a requester;
determining if said requester has a personal syndication manager; and,
determining if said data source is registered with said personal syndication manager.

6. The method as claimed in claim 5, further comprising:
prompting said requester to install a personal syndication manager if said requester is determined not to have a personal syndication manager.

7. The method as claimed in claim 5, further comprising:
subscribing to said private data source through said personal syndication manager and providing said application to said requester if said requester is determined to have a personal syndication manager and said data source is determined to be registered with said personal syndication manager.

8. The method as claimed in claim 7, further comprising:
terminating a subscription to said private data source upon an occurrence of a specified condition.

9. The method as claimed in claim 8, wherein said specified condition includes expiration of a time period.

10. The method as claimed in claim 1, wherein said application comprises a mashup.

11. A system for providing content and services, which comprises:
a server, said server hosting a web-based application, said application comprising web-provided services and private data;
a private data source containing said private data; and,
a personal syndication manager in communication with said server and said private data source.

12. The system as claimed in claim 11, wherein said server is configured to subscribe to said private data source through said personal syndication manager.

13. The system as claimed in claim 12, wherein said personal syndication manager is configured to terminate a subscription to said private data source upon an event.

14. The system as claimed in claim 13, wherein said event includes expiration of a subscription period.

15. The system as claimed in claim 11, wherein said personal syndication manager is configured to communicate with a registered private data source.

16. The system as claimed in claim 11, wherein:
said personal syndication manager is configured to convert said private data to a content syndication format required by said application.

17. The system as claimed in claim 11, wherein said server comprises a mashup server.

18. An article of manufacture for implementing a method of providing content and services, which comprises:
a computer readable medium having computer readable code thereon, said computer readable code comprising:
instructions for providing private data to a server in response to a subscription request from said server.

19. The article of manufacture as claimed in claim 18, wherein said compute readable code further comprises:
instructions for converting said private data to a content syndication format required by said server.
